(19) United States
(12) Patent Application Publication
(10) Pub. No.: US 2026/0038281 A1
(43) Pub. Date: Feb. 5, 2026

(54) IDENTIFICATION METHOD AND SYSTEM FOR PARKING SPACE INFORMATION FUSION

(71) Applicant: WISTRON CORPORATION, New Taipei City (TW)

(72) Inventors: Jia Zheng JIAN, New Taipei City (TW); Ching An CHO, New Taipei City (TW); Hao Gong CHOU, New Taipei City (TW); Chih Hao CHIU, New Taipei City (TW)

(73) Assignee: WISTRON CORPORATION, New Taipei City (TW)

(21) Appl. No.: 18/914,618

(22) Filed: Oct. 14, 2024

(30) Foreign Application Priority Data
Aug. 1, 2024 (TW) 113128845

(51) Int. Cl. G06V 20/58; G01C 21/00; G06V 10/44; G06V 10/75; G06V 10/762; G06V 10/80

(52) U.S. Cl. CPC G06V 20/586; G01C 21/3811; G06V 10/44; G06V 10/751; G06V 10/762; G06V 10/80

(57) ABSTRACT

An identification method configured to process parking space information, which includes a plurality of entry corners and a plurality of entry lines. The method includes: grouping the plurality of entry corners into a plurality of entry corner clusters based on the coordinates of each entry corner; screening a plurality of entry corners included in each of the entry corner clusters for a representative entry corner; matching the plurality of entry lines with each representative entry corner based on the coordinates of the entry lines, to group the entry lines into a plurality of entry line clusters, where each of the entry line clusters includes two representative entry corners and one or more entry lines; collecting statistics based on the coordinates and the attribute of the one or more entry lines included in each entry line cluster, to respectively define representative coordinates and a representative attribute for each entry line cluster.

### CROSS-REFERENCE TO RELATED APPLICATION

This application claims the priority and benefit of Taiwan Patent Application No. 113128845 filed on Aug. 1, 2024, the disclosure of which is hereby incorporated in its entirety by reference herein.

### TECHNICAL FIELD

The present disclosure relates to an image analysis system, and in particular, to an image analysis system applicable to identification of a parking space.

### BACKGROUND

An advanced driver assistance system (ADAS) is a technology dedicated to assisting or even replacing driving to achieve safe driving. An automated parking system/automated parking assistant (APS/APA) is one of common functions of the ADAS, algorithms thereof mainly include modules such as parking space detection (PSD), path planning, and automatic control, and the PSD may be further divided into detection of marked parking spaces or detection of unmarked parking spaces.

In recent years, deep learning-based PSD methods have made significant progress, and some studies obtain parking space information based on a deep convolutional neural network (DCNN). However, although the methods have achieved good results under different environmental conditions, a same image feature is repeatedly processed as a result of multi-stage image identification and determining, resulting in a lot of processing time and making it difficult to meet real-time requirements of vehicle control.

### SUMMARY

In view of this, the inventor provides an identification method for parking space information fusion, configured for processing parking space information. The parking space information includes a plurality of entry corners and a plurality of entry lines. Each of the entry corners includes coordinates and an attribute, and each of the entry lines includes coordinates and an attribute. The identification method includes: grouping, by a processor, the plurality of entry corners into a plurality of entry corner clusters based on the coordinates of each entry corner; screening, by the processor, a plurality of entry corners included in each of the entry corner clusters for a representative entry corner; matching, by the processor, the plurality of entry lines with each representative entry corner based on the coordinates of the entry line, to group the entry lines into a plurality of entry line clusters, where each of the entry line clusters includes two representative entry corners and one or more entry lines; and collecting, by the processor, statistics based on the coordinates and the attribute of the one or more entry lines included in each entry line cluster, to respectively define representative coordinates and a representative attribute for each entry line cluster.

The inventor further provides an identification method for parking space information fusion, configured for processing image information. The image information includes a plurality of parking space images. The identification method includes: executing, by a processor, an image identification model, where the image identification model generates a plurality of entry corners and a plurality of entry lines of each of the parking space images, each of the entry corners includes coordinates and an attribute, and each of the entry lines includes coordinates and an attribute; grouping, by the processor, the plurality of entry corners into a plurality of entry corner clusters based on the coordinates of each entry corner; screening, by the processor, a plurality of entry corners included in each entry corner cluster for a representative entry corner; matching, by the processor, the plurality of entry lines with each representative entry corner based on the coordinates of the entry lines, to group the entry lines into a plurality of entry line clusters, where each of the entry line clusters includes two representative entry corners and the one or more entry lines; and collecting, by the processor, statistics based on the coordinates and the attribute of the one or more entry lines included in each entry line cluster, to respectively define representative coordinates and a representative attribute for each entry line cluster.

The inventor further provides an identification system for parking space information fusion, including a memory and a processor. The memory is configured to store parking space information. The parking space information includes a plurality of entry corners and a plurality of entry lines. Each of the entry corners includes coordinates and an attribute, and each of the entry lines includes coordinates and an attribute. The processor is configured to: read the parking space information from the memory; group the plurality of entry corners into a plurality of entry corner clusters based on the coordinates of each entry corner; screen a plurality of entry corners included in each of the entry corner clusters for a representative entry corner; match the plurality of entry lines with each representative entry corner based on the coordinates of the entry lines, to group the entry lines into a plurality of entry line clusters, where each of the entry line clusters includes two representative entry corners and one or more entry lines; and collect statistics based on the coordinates and the attribute of the one or more entry lines included in each entry line cluster, to respectively define representative coordinates and a representative attribute for each entry line cluster.

### BRIEF DESCRIPTION OF THE DRAWINGS

FIG. 1A to FIG. 1D are schematic diagrams of image information according to some embodiments;

FIG. 2A to FIG. 2C are schematic diagrams of detecting a parking space image according to a line segment detection method;

FIG. 3A to FIG. 3D are schematic diagrams of detecting a parking space image according to a corner detection method;

FIG. 4A is a partially enlarged schematic view of a box position in FIG. 3A;

FIG. 4B is a partially enlarged schematic view of a box position in FIG. 3B;

FIG. 4C is a partially enlarged schematic view of a box position in FIG. 3C;

FIG. 4D is a partially enlarged schematic view of a box position in FIG. 3D;

FIG. 5 is a schematic diagram of an angle classification template of a corner according to some embodiments;

FIG. 6 is a schematic block diagram of an identification system according to some embodiments;

FIG. 7 is a flowchart of an identification method according to some embodiments;

FIG. 8A is a schematic diagram of image identification according to some embodiments;

FIG. 8B is a schematic diagram of entry corners outputted by an image identification model according to some embodiments;

FIG. 8C is a schematic diagram of entry lines outputted by an image identification model according to some embodiments;

FIG. 9 is a flowchart of screening of an entry corner according to some embodiments;

FIG. 10A to FIG. 10C are schematic diagrams of screening of an entry corner according to some embodiments;

FIG. 11 is a flowchart of matching an entry corner with an entry line according to some embodiments;

FIG. 12A to FIG. 12B are schematic diagrams of matching an entry corner with an entry line according to some embodiments;

FIG. 13 is a flowchart of entry line screening according to some embodiments;

FIG. 14A to FIG. 14D are schematic diagrams of entry line screening according to some embodiments;

FIG. 15A is a flowchart of deleting an incorrect included angle between parking spaces according to some embodiments;

FIG. 15B is a flowchart of deleting an incorrect included angle between parking spaces according to some other embodiments;

FIG. 16A to FIG. 16D are schematic diagrams of initial points of vectors of two entry lines that are paired together according to some embodiments;

FIG. 17A to FIG. 17D are schematic diagrams of an initial point of a vector of an entry line and a terminal point of a vector of another entry line that are paired together according to some embodiments;

FIG. 18 is a flowchart of information fusion according to some embodiments;

FIG. 19A to FIG. 19D are schematic diagrams of information fusion according to some embodiments;

FIG. 20A is a schematic diagram of a panoramic image of parking space information according to some embodiments;

FIG. 20B is a schematic diagram of a panoramic image of output information of an identification method according to some embodiments;

FIG. 20C is a schematic diagram of a panoramic image of a verification result according to some embodiments; and

FIG. 21A to FIG. 21B are statistical comparison diagrams of an identification method according to some embodiments and an actual measurement result in the prior art.

### DETAILED DESCRIPTION

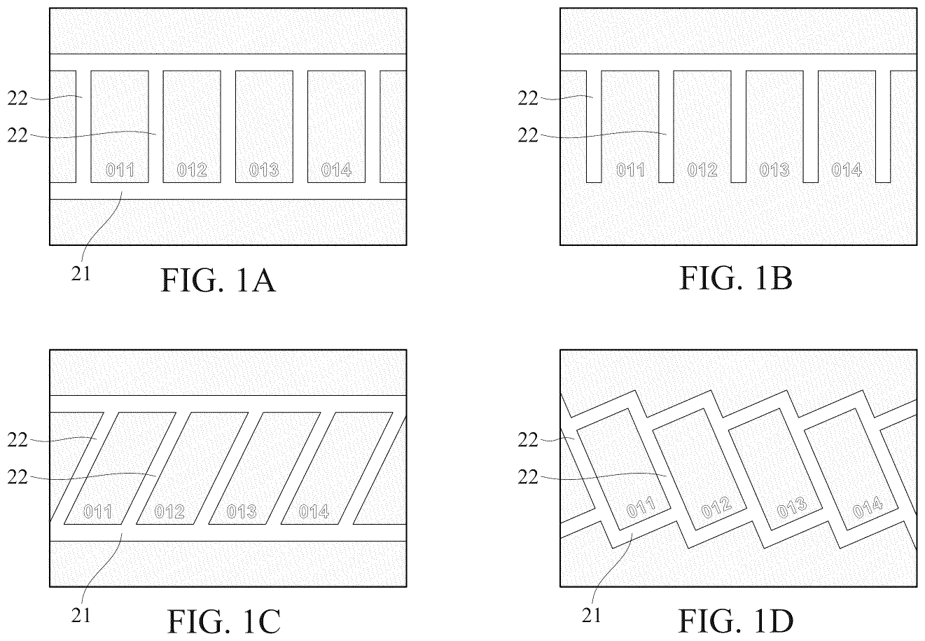

FIG. 1A to FIG. 1D are schematic diagrams of image information according to some embodiments. Refer to FIG. 1A first. In this embodiment, the image information includes a plurality of parking space images, namely, parking space images numbered “011”, “012”, “013”, and “014”. The parking space image may include an entry line image 21 and a side line image 22, which may be an image formed through capturing paint lines on a road surface by a camera. The entry line image 21 may correspond to a transverse line at an entry end of a parking space, which may be configured to help a driver confirm whether a vehicle exceeds a range from the parking space to a road. The side line image 22 may correspond to longitudinal lines on left and right sides of the parking space, which may be configured to help the driver confirm whether the vehicle extends to an adjacent parking space. In this embodiment, a parking space type presented in the parking space image is a vertical parking space. When the vehicle is correctly parked in the vertical parking space, a head-tail direction thereof is perpendicular to an entry paint line. In some other embodiments, the parking space type may be a parallel parking space (not shown in the figure). When the vehicle is correctly parked in the parallel parking space, the head-tail direction thereof is parallel to the entry paint line, for example, a parking space commonly seen on a roadside. However, regardless of the vertical parking space or the parallel parking space, the entry line image 21 and the side line image 22 are both perpendicular to each other.

In some embodiments, the entry line image 21 may not exist. Referring to FIG. 1B, a vertical parking space in this embodiment includes only the side line image 22. Nevertheless, a virtual entry line may still be defined based on endpoints of the side line image 22. In some other embodiments, the entry line image 21 and the side line image 22 are not perpendicular to each other. Referring to FIG. 1C, in this embodiment, a parking space type presented in the parking space image is a slant parking space. When the vehicle is correctly parked in the slant parking space, an included angle is presented between a head-tail direction of the vehicle and a direction of the entry paint line. The parking space type may be identified based on a direction of an entry line. Referring to FIG. 1D, although an included angle seems to be presented between a direction of each parking space image and a road travel direction (a left-right direction in FIG. 1D), the entry line image 21 and the side line image 22 of each parking space image are both perpendicular to each other. Therefore, the parking space type belongs to the vertical parking space.

Distinguishing the parking space type by a vehicle control system is that different vehicle control programs may be adopted based on different parking space types. An advanced driver assistance system (ADAS) is used as an example. For the vertical parking spaces shown in FIG. 1A, FIG. 1B, and FIG. 1D, the ADAS only needs to control the vehicle to rotate left wheels and right wheels at a same speed in the direction of the vertical entry line to complete reverse parking after identifying a direction of the entry line image 21 (or the virtual entry line). For the slant parking space in FIG. 1C, after the ADAS identifies the direction of the entry line image 21, when the vehicle is in a direction perpendicular to the entry line, the ADAS needs to first determine an angle of the side line image 22 and control the left wheels and the right wheels to rotate at different speeds, so that the vehicle is slanted to a target angle, and then control the left wheels and the right wheels to rotate at a same speed, to complete the reverse parking.

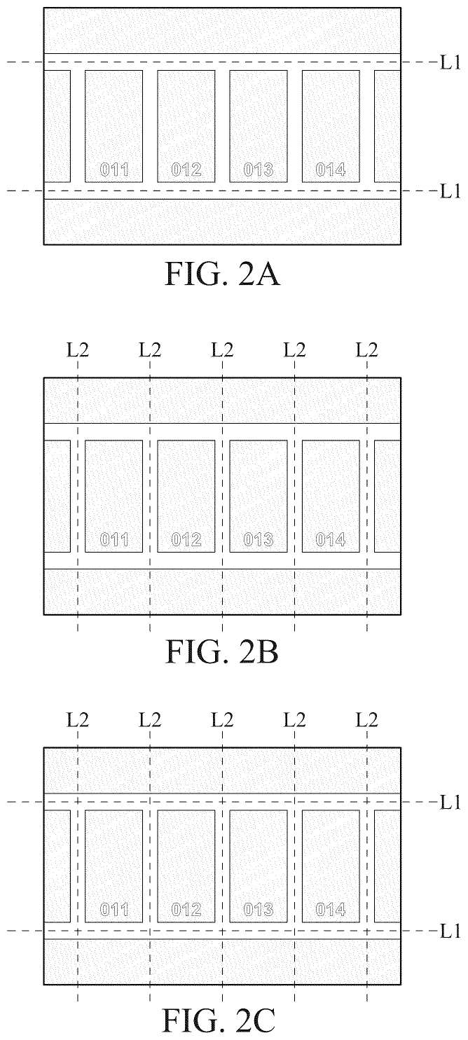

FIG. 2A to FIG. 2C are schematic diagrams of detecting a parking space image according to a line segment detection method. In this embodiment, according to the line segment detection method, a parallel paint line of a parking space image in image information is first identified, for example, a parallel identification line L1 in FIG. 2A. Then a vertical paint line of the parking space image in the image information is identified, for example, a vertical identification line L2 in FIG. 2B. Finally, a parking space is reconstructed based on the parallel identification line L1 and the vertical identification line L2.

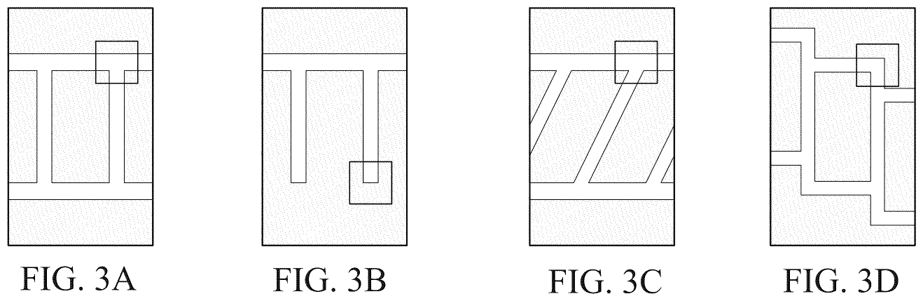

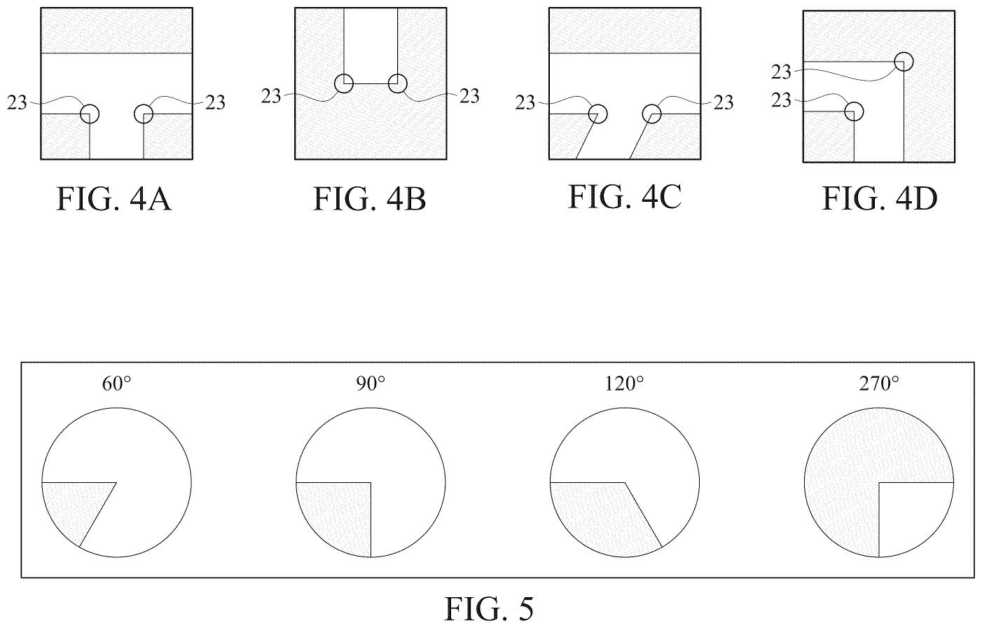

FIG. 3A to FIG. 3D are schematic diagrams of detecting a parking space image according to a corner detection method. The corner detection method is configured for identifying a junction or an end of paint lines of the parking space image in image information. As shown in FIG. 3A and FIG. 4A, or FIG. 3D and FIG. 4D, a corner 23 where a parallel paint line is orthogonal to a vertical paint line is identified. The corner detection method is also configured for identifying the parking space as shown in FIG. 1B. As shown in FIG. 3B and FIG. 4B, a corner 23 located at an end of the vertical paint line is identified. In addition, the corner detection method is also configured for identifying a slant parking space. As shown in FIG. 3C and FIG. 4C, a corner 23 at a junction of the parallel paint line and the slant paint line is identified.

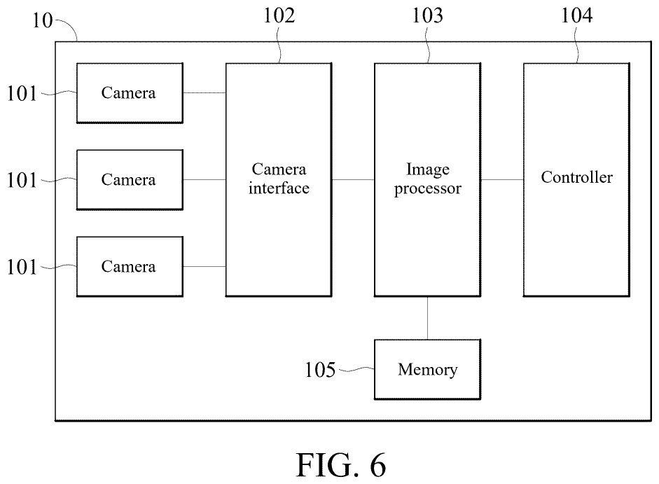

FIG. 5 is a schematic diagram of an angle classification template of a corner according to some embodiments. Refer to FIG. 5. According to the corner detection method, the parking space type may be determined through an angle of the corner 23. In detail, according to the corner detection method, the corners 23 identified in FIG. 4A to FIG. 4D are matched with the angle classification templates in FIG. 5, and then a geometric feature of the parking space image is reconstructed based on the angle of each corner 23, to determine the parking space type.

FIG. 6 is a schematic block diagram of an identification system according to some embodiments. Refer to FIG. 6. In this embodiment, an identification system 10 includes a plurality of cameras 101, a camera interface 102, an image processor 103, a controller 104, and a memory 105. The plurality of cameras 101 are coupled to the camera interface 102. The camera interface 102 is coupled to the image processor 103. The image processor 103 is coupled to the controller 104 and the memory 105. The coupling may refer to a wired connection or a wireless connection, for example but not limited to a connection through a bus or a connection through wireless communication.

Each of the cameras 101 is not limited to a visible or non-visible light image sensor, and may be mounted around a vehicle. The camera interface 102 may be connected to a plurality of cameras 101 of a same type or different types in series to integrate information from the plurality of cameras into single information for transmission, for example, but not limited to being connected to the plurality of cameras 101 in series through a gigabit multimedia serial link (GMSL). The image processor 103 or the controller 104 may be an electronic control unit (ECU), for example, but not limited to a micro-control unit (MCU), a central processing unit (CPU), a graphics processing unit (GPU), a neural processing unit (NPU), an application specific integrated circuit (ASIC), a field programmable gate array (FPGA), or a system on a chip (SoC).

The image processor 103 and the controller 104 may be independent chips, or may be different functional modules processed by a same chip. For example, the image processor 103 is the NPU, and is configured to process image information captured by a plurality of cameras 101 (which may splice panoramic images) and perform an identification method in some embodiments of the present disclosure. The controller 104 is the CPU, and is configured to control the vehicle to move based on representative coordinates or a representative attribute outputted through the identification method. In this embodiment, all components of the identification system 10 are configured in the vehicle. In another embodiment, the image processor 103 may be arranged on a remote server, and the controller 104 may be an on-board ECU. The camera interface 102 and the controller 104 may be indirectly connected to the image processor 103 on a server side through wireless communication. Based on this, a manager may maintain and manage, through a cloud platform, the identification method performed by a server.

The memory 105 may be a flash memory or a read-only memory (ROM), for example, but not limited to an erasable programmable ROM (EPROM), a flash ROM (flash ROM), or a field-replaceable unit (FRU). The memory 105 may store parking space information, and the image processor 103 reads the parking space information for processing.

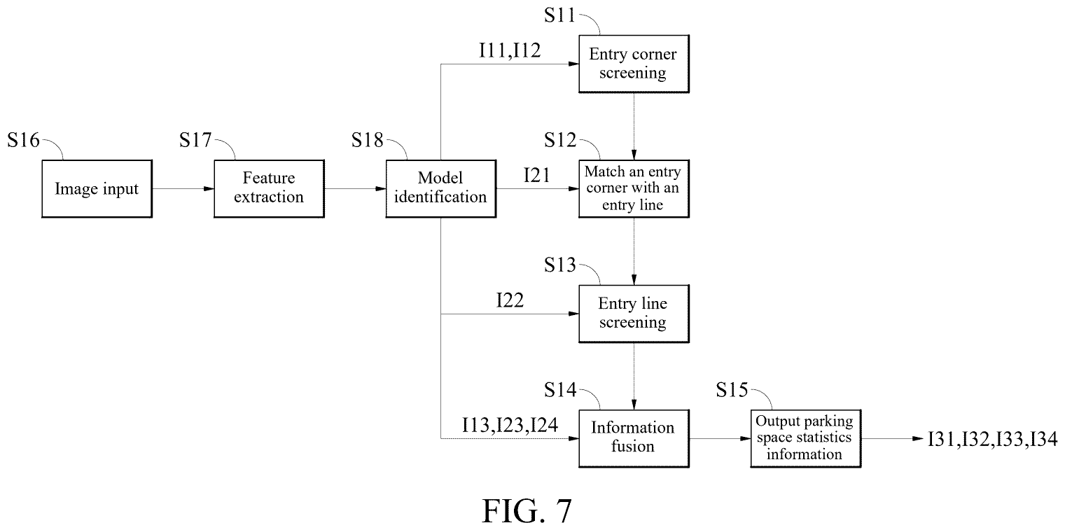

FIG. 7 is a flowchart of an identification method according to some embodiments. Refer to FIG. 7. In some embodiments, the identification method includes step S11 to step S15, and the identification method is configured for processing parking space information. The parking space information includes a plurality of entry corners 43 and a plurality of entry lines 44. Each of the entry corners 43 may refer to a marking point identified by an image identification model for a feature of a corner 23 at an entry of a parking space. Each of the entry lines 44 may refer to a marking line identified by the image identification model based on a feature of an entry line image 21 at the entry of the parking space. The entry corner 43 includes coordinates I11 and an attribute. The coordinates I11 of the entry corner 43 may refer to coordinates of a center of the entry corner 43 relative to any point in an image, for example, but not limited to coordinates relative to a center point of a driving vehicle 31. The attribute of the entry corner 43 may include one or more selected from a group consisting of a probability value I12 and a parking space angle I13. The probability value I12 may refer to an accuracy of estimating the corner 23 of the parking space by the image identification model for the entry corner 43. The parking space angle I13 may refer to an angle of the side line image 22 relative to an axis of the driving vehicle 31, or an angle of the side line image 22 relative to the entry line image 21.

The entry line 44 includes coordinates I21 and an attribute. The coordinates I21 of the entry line 44 may refer to coordinates of a midpoint or any endpoint of the entry line 44 relative to any point in the image. In some embodiments, the entry line 44 includes two endpoints, and the two endpoints form a vector. The vector may correspond to a parking space position identified by the image identification model. For example, when a right side of the vector is a parking space, a left side of the vector is a lane. The attribute of the entry line 44 may include one or more selected from a group consisting of a probability value I22, a parking space type I23, and an occupancy state I24. The probability value I22 may refer to an accuracy of estimating a physical or virtual entry line of the parking space by the image identification model for the entry line 44. The parking space type I23 may refer to different parking space classification marks of the image identification model, for example, but not limited to a vertical parking space ver, a parallel parking space par, or a slant parking space slt. The occupancy state I24 may refer to a state whether the parking space presented in the image information has been occupied by a surrounding vehicle 33.

In some embodiments, the identification method includes step S11 to step S18. In detail, refer to FIG. 7 first. An image processor 103 receives an image input (step S16), which includes a plurality of parking space images. The image processor 103 performs feature extraction on the parking space (step S17), to obtain local features. Then the image processor 103 performs model identification (step S18), and the image identification model determines the entry corners 43 and the entry lines 44 of each parking space image based on the local feature.

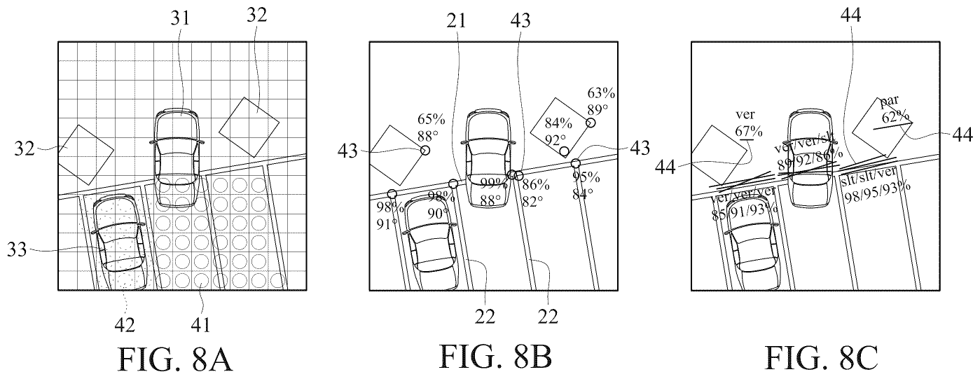

FIG. 8A is a schematic diagram of image identification according to some embodiments. Refer to FIG. 8A. In detail, the image processor 103 performs feature extraction to segment the image information into a plurality of grids, and analyzes local features of a parking space and a vehicle. An image identification model determines whether cach grid includes a parking space that is not occupied by the surrounding vehicle 33, and marks the grid with an empty space identification mark 41; determines whether each grid includes a parking space that is occupied by the surrounding vehicle 33, and marks the grid with an occupation identification mark 42; and determines that each grid does not include a parking space, and does not mark the grid. Based on this, it may be determined by the image identification model that an occupancy state I24 of the parking space occupied by the surrounding vehicle 33 in FIG. 8A is occupied. In addition, the image identification model may generate a vector of the entry line 44 depending on whether an identification mark exists on the left side or the right side of the entry line 44. Moreover, coverage of the parking space is confirmed through the identification mark, so that the parking space type I23, the coordinates I11 of the entry corner 43, and the coordinates I21 of the entry line 44 may be confirmed.

FIG. 8B is a schematic diagram of entry corners outputted by an image identification model according to some embodiments. Refer to FIG. 8B. In this embodiment, a parking space image includes an entry line image 21 and a side line image 22, and the image identification model determines an entry corner 43 based on image information. FIG. 8B shows coordinates I11, a probability value I12, and a parking space angle I13 of the entry corner 43. In this embodiment, at least a plurality of problems exist in an output result of the image identification model: (1) A corner of an obstacle near an entry of the parking space image, for example, a corner of a pillar 32, may be erroneously determined as having the entry corner 43. (2) A same corner 23 at a same image position, for example, a corner 23 on a right side of a driving vehicle 31 in FIG. 8B, may be incorrectly determined as a plurality of entry corners 43. (3) The parking space angle I13 determined by the image identification model based on different identification marks in a same parking space may vary, causing different entry corners 43 of the same parking space to have different angle values.

FIG. 8C is a schematic diagram of entry lines outputted by an image identification model according to some embodiments. The image identification model determines the entry line 44 based on the image information. FIG. 8C shows coordinates I21, a probability value I22, and a parking space type I23 of the entry line 44. In this embodiment, at least a plurality of problems exist in an output result of the image identification model: (1) A boundary or pattern of an obstacle adjacent to an entry in a parking space image, for example, an edge of a pillar 32, may be erroneously determined as an entry line 44. (2) A same entry line image 21 at a same image position may be incorrectly determined as a plurality of entry lines 44. (3) The parking space type I23 determined by the image identification model based on different identification marks in a same parking space may be different. For example, a parking space that a driving vehicle 31 is expected to enter in FIG. 8C is determined as a vertical parking space ver in a secondary identification process, and is determined as a slant parking space slt in a primary identification process.

Referring to FIG. 6 again, in some embodiments, the output result of the image identification model may be stored in the memory 105 as the parking space information. The image processor 103 reads the parking space information and performs the identification method. For case of description, according to an identification method of the following embodiments, the coordinates I11 and all of the attributes of the entry corner 43 as well as the coordinates I21 and all of the attributes of the entry line 44 are to be processed. It should be understood that information selection of the parking space information may be determined based on control needs or other application needs.

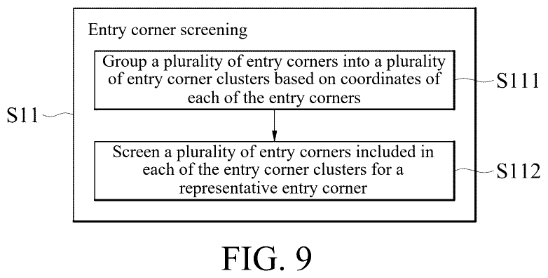

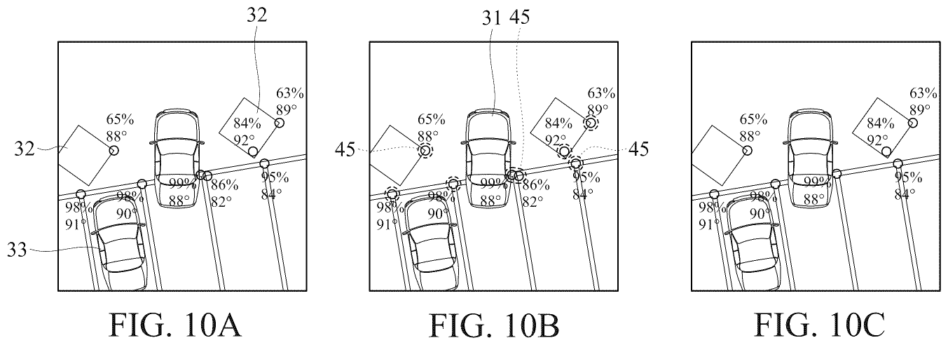

Referring to FIG. 7 again, in step S11, the image processor 103 performs screening of the entry corner 43. In this embodiment, the image processor 103 reads the coordinates I11 and the probability value I12 of the entry corner 43, and performs the screening of the entry corner 43. FIG. 9 is a flowchart of screening of an entry corner according to some embodiments. Refer to FIG. 9. In detail, first, an image processor 103 groups a plurality of entry corners 43 into a plurality of entry corner clusters 45 based on coordinates I11 of each of the entry corners 43 (step S111). FIG. 10A to FIG. 10C are schematic diagrams of screening of an entry corner according to some embodiments. Refer to FIG. 10A first. In this embodiment, parking space information includes a total of 8 entry corners 43, of which 3 are located at corners of a pillar 32 and 5 are located at corners 23 of a parking space. Then referring to FIG. 10B, an image processor 103 grouping the 8 entry corners 43 into 7 entry corner clusters 45 based on coordinates I11 of each of the entry corners 43. In detail, in an embodiment, the image processor 103 searches for the entry corners 43 one by one based on a recursive logic method, and merges entry corners 43 with a relatively small distance (for example, the distance is less than an average distance) into a same entry corner cluster 45. In another embodiment, the image processor 103 determines that a distance between any two entry corners 43 is less than a first distance threshold, and merges the two entry corners 43 into the same entry corner cluster 45. In some embodiments, the first distance threshold refers to a distance less than a width of a driving vehicle 31, for example, a distance equal to half the width of the driving vehicle 31.

Then the image processor 103 screens a plurality of entry corners 43 included in each entry corner cluster 45 for a representative entry corner 43 (step S112). In an embodiment, the image processor 103 screens an entry corner 43 with a maximum probability value as the representative entry corner 43 based on probability values 112 of a plurality of entry corners 43 included in the entry corner cluster 45. Refer to FIG. 10B and FIG. 10C together. In FIG. 10B, an entry corner cluster 45 on a right side of the driving vehicle 31 includes two entry corners 43 (which respectively have a probability value of 99% and a probability value of 86%), and in FIG. 10C, a representative entry corner 43 (having a probability value of 99%) is presented on the right side of the driving vehicle 31. In this way, a plurality of entry corners 43 that are repeatedly determined by the image identification model at a position of a same corner 23 are excluded, to avoid duplicating a plurality of overlapping parking spaces in a same position.

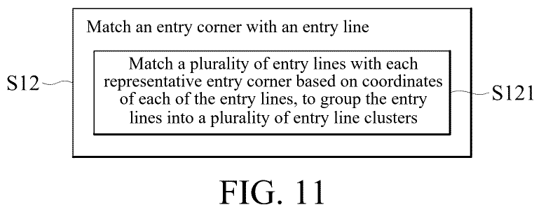

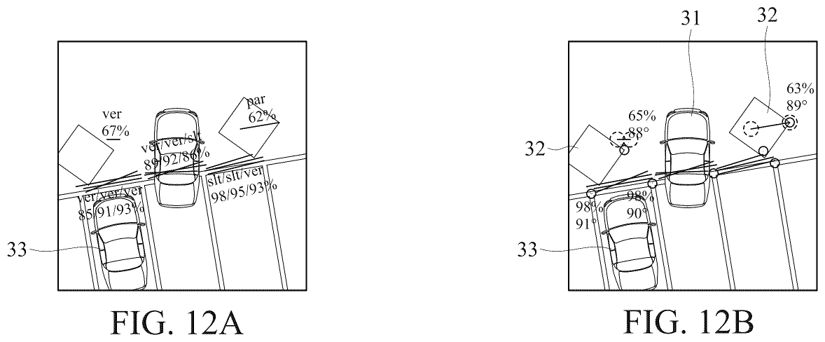

Referring to FIG. 7 again, in step S12, the image processor 103 matches the entry corner 43 with the entry line 44. In this embodiment, the image processor 103 reads the coordinates I21 of the entry line 44, and matches the entry corner 43 with the entry line 44 based on coordinates I11 of the representative entry corner 43 generated in step S11. FIG. 11 is a flowchart of matching an entry corner with an entry line according to some embodiments. Refer to FIG. 11. In detail, an image processor 103 matches a plurality of entry lines 44 with each representative entry corner 43 based on coordinates I21 of each of the entry lines 44, to group the entry lines into a plurality of entry line clusters (step S121). FIG. 12A to FIG. 12B are schematic diagrams of matching an entry corner with an entry line according to some embodiments. Refer to FIG. 10A and FIG. 12A together. In this embodiment, an image identification model generates the plurality of entry corners 43 in FIG. 10A and a plurality of entry lines 44 in FIG. 12A. The image processor 103 determines that a distance between each of the entry lines 44 and a representative entry corner 43 surrounding the entry line is less than a second distance threshold, and merges the representative entry corner 43 and the entry line 44 into a same entry line cluster. In some embodiments, the foregoing distance may refer to a distance between a midpoint of the entry line 44 and a center point of the representative entry corner 43. In this embodiment, the foregoing distance refers to a distance between either of the two endpoints of the entry line 44 and the center point of the representative entry corner 43. The second distance threshold may be represented by the following Equation I:

$$T = \vert Pl - Pr \vert \times n \% \qquad ( Equation I )$$

where T is the second distance threshold, Pₗ and Pᵣ are the coordinates I21 of the two endpoints of the entry line 44, and n is a proportion value, which may be adjusted based on strictness of screening conditions. In an embodiment, n is set to 50, to search for the representative entry corner 43 within a distance range about half of a width of the parking space around the endpoints of the entry line 44.

For example, in FIG. 10A, a parking space occupied by a surrounding vehicle 33 is marked with a total of two representative entry corners 43 (which respectively have a probability value of 98% and a probability value of 98%), and in FIG. 12A, a parking space occupied by the surrounding vehicle 33 is marked with a total of three entry lines 44 (which respectively have a probability value of 85%, a probability value of 91%, and a probability value of 93%). Referring to FIG. 12B, the image processor 103 sequentially searches for representative entry corners 43 around two endpoints of each of the three entry lines 44 within a range of the second distance threshold, and matches the three entry lines with two representative entry corners 43 with the probability value of 98%. Herein, the two representative entry corners 43 with the probability value of 98% and the three entry lines 44 (with the probability values of 85%, 91%, and 93%) together form an entry line cluster. It may be found through observation of FIG. 12B that the representative entry corner 43 may belong to two entry line clusters at the same time. For example, a representative entry corner 43 located between the parking space occupied by the surrounding vehicle 33 and a parking space that the driving vehicle 31 is expected to park is included in the two entry line clusters.

In some embodiments, an error condition may exist in the entry line cluster. For example, a case in which two endpoints of a same entry line 44 are simultaneously paired with a same representative entry corner 43 occurs at a pillar 32 on a left side in FIG. 12B. In addition, a case in which one of endpoints of an entry line 44 is paired with a representative entry corner 43 and the other endpoint is not paired with the representative entry corner 43 occurs at a pillar 32 on a right side in FIG. 12B. Therefore, in some embodiments, the entry lines 44 in the entry line cluster needs to be screened to exclude the error conditions.

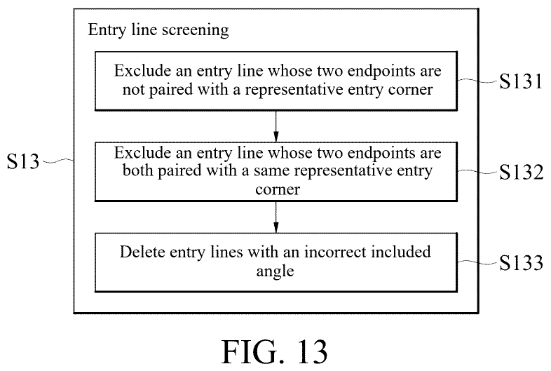

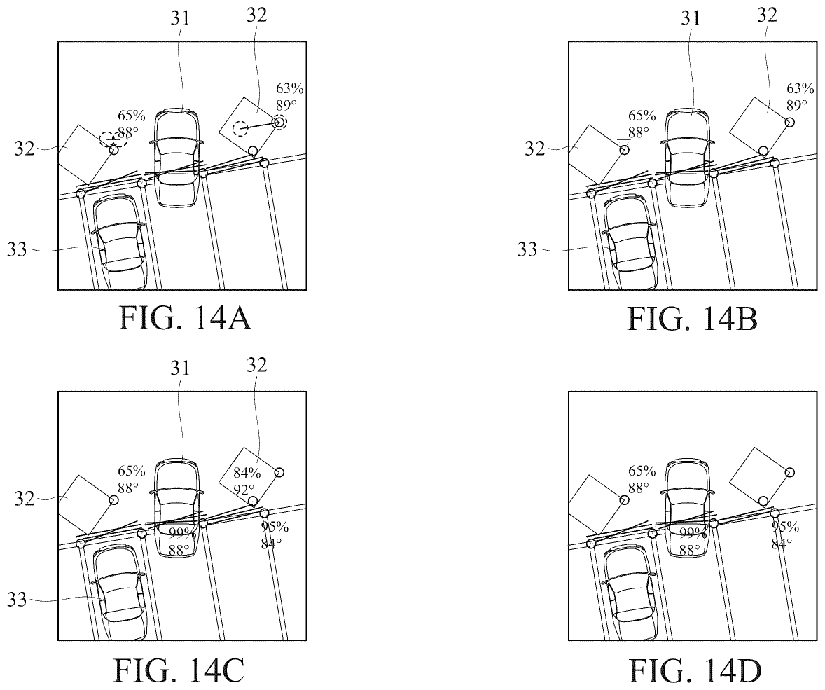

Referring to FIG. 7 again, in step S13, the image processor 103 performs screening of the entry line 44. In this embodiment, the image processor 103 reads the probability value 122 of the entry line 44, and performs screening of the entry line 44. FIG. 13 is a flowchart of screening of an entry line 44 according to some embodiments. Refer to FIG. 13. In detail, in some embodiments, the image processor 103 excludes an entry line 44 whose two endpoints are not paired with the representative entry corner 43 (step S131). FIG. 14A to FIG. 14D are schematic diagrams of screening of an entry line according to some embodiments. Refer to FIG. 14A and FIG. 14B first. In this embodiment, an image processor 103 determines that two endpoints of the entry line 44 at the pillar 32 on a right side in FIG. 14A are not paired with a representative entry corner 43 (only an endpoint on a right side is paired with the representative entry corner 43), and therefore excludes the entry line 44. The exclusion may involve either deleting data of the entry line 44, or excluding the entry line 44 from an entry line cluster. In this embodiment, after the image processor 103 excludes the entry line 44 in an entry line cluster at the pillar 32 on the right side in FIG. 14A, the entry line cluster does not include the entry line 44 and is removed (refer to FIG. 14B).

In some embodiments, the image processor 103 excludes an entry line 44 whose two endpoints are both paired with a same representative entry corner 43 (step S132). Then referring to FIG. 14B and FIG. 14C, in this embodiment, the image processor 103 determines that two endpoints of an entry line 44 at a pillar 32 on a left side in FIG. 14B are both paired with the same representative entry corner 43, and therefore excludes the entry line 44. In this embodiment, after the image processor 103 excludes the entry line 44 in an entry line cluster at the pillar 32 on the left side in FIG. 14B, the entry line cluster no longer includes the entry line 44 and is dissolved (refer to FIG. 14C).

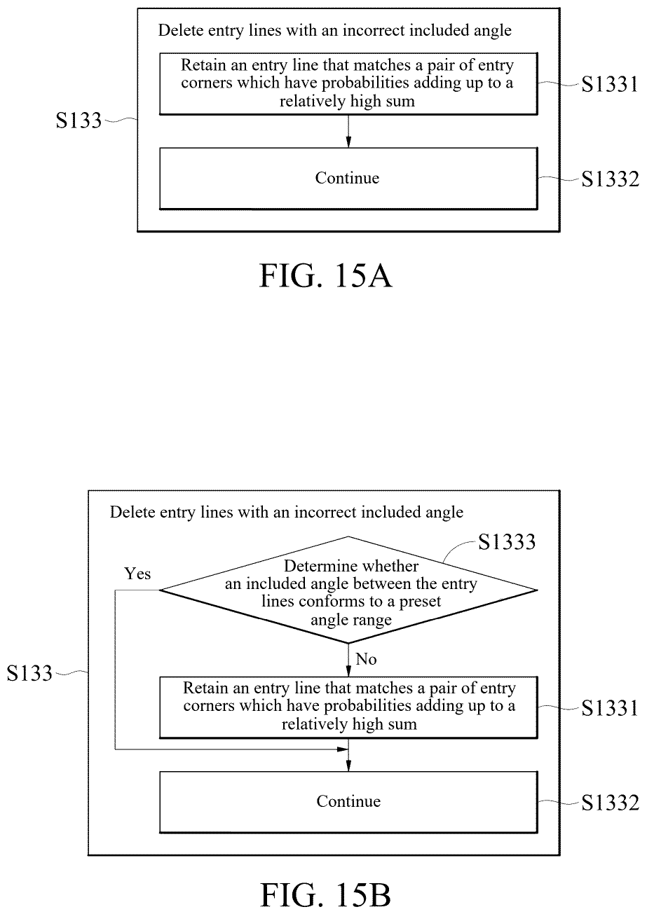

In some embodiments, entry lines 44 with an incorrect included angle are deleted (step S133). Then referring to FIG. 14C and FIG. 14D, in this embodiment, the image processor 103 determines that an entry corner 43 (with a probability value of 99%) on a right side of a driving vehicle 31 is paired with one of endpoints of each of two entry lines 44. FIG. 15A is a flowchart of deleting an incorrect included angle between parking spaces according to some embodiments. Refer to FIG. 15A and FIG. 14C. In this embodiment, the image processor 103 retains an entry line 44 that matches a pair of entry corners which have probability values 112 adding up to a relatively high sum (step S1331), and then continues a next processing process (step S1332). Herein, the pair of entry corners refer to entry corners 43 respectively paired with the two endpoints of each of the entry lines 44. For example, in FIG. 14C, among a plurality of entry lines 44 matching the entry corner 43 (with the probability value of 99%) on the right side of the driving vehicle 31, the other endpoint of one entry line 44 is paired with an entry corner 43 (with a probability value of 84%) at the pillar 32 on the right side, and the other endpoint of the other entry line 44 is paired with an entry corner 43 (with a probability value of 95%) at a parking space on the right side of the driving vehicle 31. Therefore, the entry corner 43 (with the probability value of 99%) and the entry corner 43 (with the probability value of 84%) form a pair of entry corners, and the entry corner 43 (with the probability value of 99%) and the entry corner 43 (with the probability value of 95%) also form a pair of entry corners. In this embodiment, the image processor 103 retains one of the two entry lines 44, and a probability value (that is, 95%) of a representative entry corner 43 paired with the other endpoint of the entry line 44 that is retained is greater than a probability value (that is, 84%) of another representative entry corner 43 paired with the other endpoint of the entry line 44 that is not retained. In other words, a sum (99% plus 95%) of the probability values 112 of the pair of entry corners is greater than a sum (99% plus 84%) of the probability values 112 of another pair of entry corners. Therefore, an entry line 44 simultaneously matching the entry corner 43 on the right side of the driving vehicle 31 and the entry corner 43 at the pillar 32 on the right side is excluded (refer to FIG. 14D).

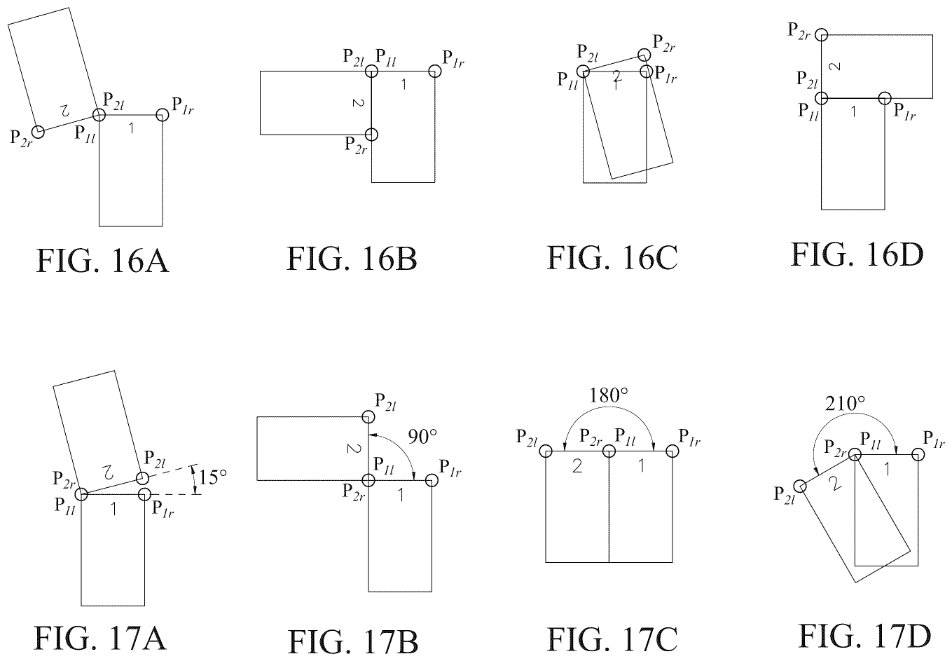

FIG. 15B is a flowchart of deleting an incorrect included angle between parking spaces according to some other embodiments. Refer to FIG. 15B. A main difference between this embodiment and the embodiment of FIG. 15A is that a determining process is added before step S1331, that is, determining whether an included angle between the entry lines 44 is consistent with a preset angle range (step S1333). When an image processor 103 determines that the included angle between the entry lines 44 is consistent with the preset angle range (a determining result of step S1333 is “yes”), step S1331 is skipped and the next processing process is continued (step S1332). When the image processor determines that the included angle between the entry lines 44 is inconsistent with the preset angle range (the determining result of step S1333 is “no”), step S1331 is performed. FIG. 16A to FIG. 16D are schematic diagrams of initial points of vectors of two entry lines that are paired together according to some embodiments. Refer to FIG. 16A first. In some embodiments, an image identification model determines a vector of each of the entry lines 44 to identify a relationship between a parking space and a lane, and outputs the relationship as parking space information. In this embodiment, coordinates 121 of the entry line 44 include a vector. In other words, two endpoints of the entry line 44 have directionality. An initial point P₁₁ of a vector of a parking space 1 points to a terminal point P₁ᵣ of the vector, and an initial point P₂₁ of a vector of a parking space 2 points to a terminal point P₂ᵣ of the vector. In real life, parking space distributions in the embodiments of FIG. 16A to FIG. 16D do not exist. A feature of the parking space distributions is that initial points (or terminal points) of vectors of two entry lines 44 are both paired with a same entry corner 43. Therefore, in this embodiment, when the image processor 103 determines that endpoints of each of the two entry lines 44 both correspond to the initial point or the terminal point of the vector, it indicates that an included angle between the two entry lines 44 is incorrect (the determining result of step S1333 is “no”), and step S1331 is performed.

FIG. 17A to FIG. 17D are schematic diagrams of an initial point of a vector of an entry line and a terminal point of a vector of another entry line that are paired together according to some embodiments. Refer to FIG. 17A to FIG. 17D together. In the embodiments, an initial point P₁₁ of a vector of a parking space 1 and a terminal point P₂ᵣ of a vector of a parking space 2 are paired with the same entry corner 43. An included angle between an entry line 44 of the parking space 1 and an entry line 44 of the parking space 2 may be calculated based on the following Equation II:

$$rad = {tan}^{- 1} \frac{V {2}_{y}}{V {2}_{x}} - {tan}^{- 1} \frac{V {1}_{y}}{V {1}_{x}} \qquad ( Equation II )$$

where V1ₓ and V2ₓ are x components of a vector of an entry line 44, V1_{y} and V2_{y} are y components of a vector of an entry line 44, and rad is an included angle between the two entry lines 44. In this embodiment, when an image processor 103 determines that endpoints of each of the two entry lines 44 respectively correspond to the initial point and the terminal point of the vector, it indicates that the included angle between the two entry lines 44 may be correct or incorrect. Therefore, the image processor 103 calculates the included angle between the two entry lines 44 based on Equation II, and determines whether the included angle between the entry lines 44 is consistent with a preset angle range (step S1333). In some embodiments, the preset angle range is a range of 90 degrees (including 90 degrees) to 180 degrees (including 180 degrees). When the image processor 103 determines that the included angle value between the two entry lines 44 is a numerical value outside the range of 90 degrees to 180 degrees, it indicates that the included angle between the two entry lines 44 is incorrect (a determining result of step S1333 is “no”), and step S1331 is performed. For example, the included angles between the entry lines 44 in FIG. 17A and FIG. 17D are respectively 15 degrees and 210 degrees, and such parking space distributions in the two embodiments does not exist in real life.

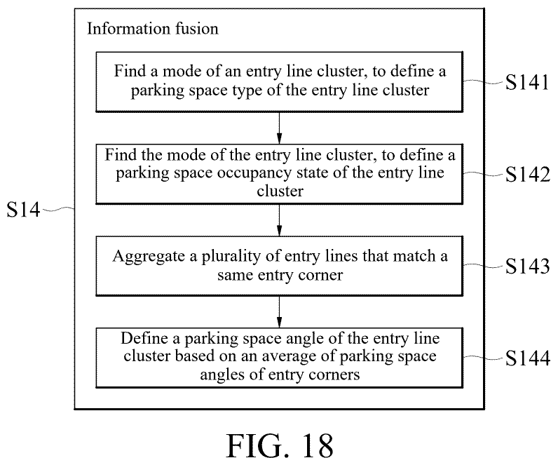

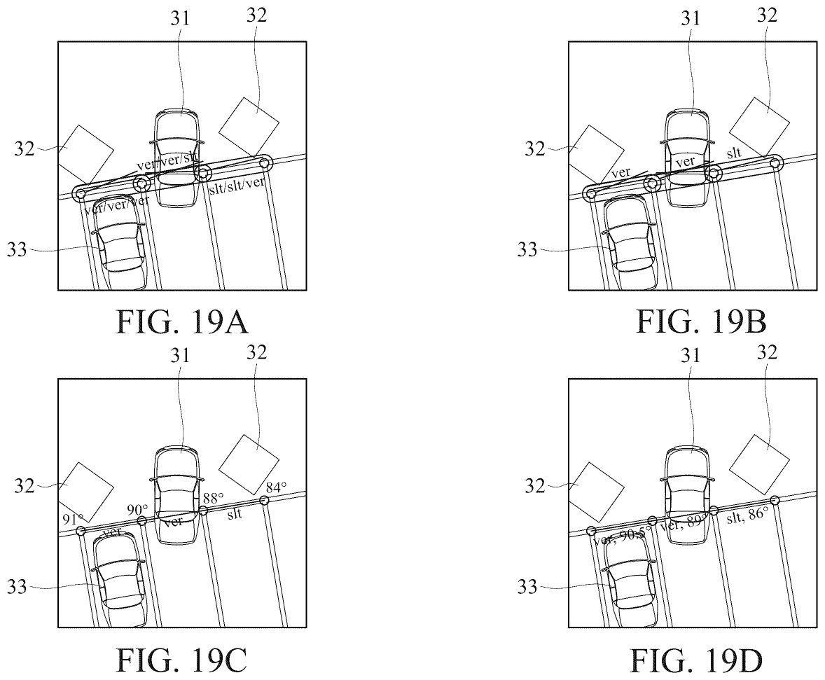

Referring to FIG. 7 again, in step S14, the image processor 103 performs information fusion. In this embodiment, the image processor 103 reads the parking space angle I13 of the entry corner 43 and the parking space type I23 and the occupancy state 124 of the entry line 44, and performs the information fusion. FIG. 18 is a flowchart of information fusion according to some embodiments. Refer to FIG. 18. The image processor 103 collects statistics based on coordinates 121 and attributes of entry lines 44 included in each entry line cluster, to respectively define representative coordinates 131 and a representative attribute for each entry line cluster. FIG. 19A to FIG. 19D are schematic diagrams of information fusion according to some embodiments. Refer to FIG. 19A and FIG. 19B first. In this embodiment, the image processor 103 finds a mode of an entry line cluster, to define a parking space type I23 of the entry line cluster (step S141). For example, in FIG. 19A, a parking space occupied by a surrounding vehicle 33 corresponds to three entry lines 44, and parking space types I23 thereof are respectively “a vertical parking space ver”, “a vertical parking space ver”, and “a vertical parking space ver”. A parking space that a driving vehicle 31 is expected to park corresponds to three entry lines 44, and parking space types I23 thereof are respectively “a vertical parking space ver”, “a vertical parking space ver”, and “a slant parking space slt”. A parking space on a right side of the driving vehicle 31 corresponds to three entry lines 44, and parking space types I23 thereof are respectively “a slant parking space slt”, “a slant parking space slt”, and “a vertical parking space ver”. After the mode processing is performed on each entry line cluster, the parking space occupied by the surrounding vehicle 33 is defined as “the vertical parking space ver”, the parking space that the driving vehicle 31 is expected to park is defined as “the vertical parking space ver”, and the parking space on the right side of the driving vehicle 31 is defined as “the slant parking space slt”. In some embodiments, the image processor 103 finds the mode of the entry line cluster, to define a parking space occupancy state of the entry line cluster (step S142). Based on this, in FIG. 19A, the parking space occupied by the surrounding vehicle 33 is defined as “occupied” (not shown in the figure), the parking space that the driving vehicle 31 is expected to park is defined as “unoccupied”, and the parking space on the right side of the driving vehicle 31 is defined as “unoccupied”.

In some embodiments, the image processor 103 aggregates a plurality of entry lines 44 matching the same entry corner 43 (step S143). For example, in FIG. 19B, three parking spaces cach have an entry line cluster. The image processor 103 aggregates a plurality of entry lines 44 in each entry line cluster into a representative entry line. In some embodiments, the image processor 103 screens an entry line 44 with a maximum probability value as the representative entry line based on probability values 112 of a plurality of entry corners 43 included in the entry line cluster. In some other embodiments, the image processor 103 calculates an average of coordinates I11 of the plurality of entry corners 43 included in the entry line cluster, to generate a representative entry line. In some other embodiments, the image processor 103 replaces two endpoints of each entry line 44 based on coordinates I11 of two representative entry corners 43 included in the entry line cluster, to define a representative entry line connecting the two representative entry corners 43.

In some embodiments, the image processor 103 defines a parking space angle I13 of the entry line cluster based on the average of the parking space angles I13 of the entry corners 43 (step S144). For example, in FIG. 19C, the parking space occupied by the surrounding vehicle 33 has two entry corners 43, and parking space angles I13 thereof are respectively 91° and 90°. Parking space angles I13 of two entry corners 43 of the parking space that the driving vehicle 31 is expected to park are respectively 90° and 88°. Parking space angles I13 of two entry corners 43 of the parking space on the right side of the driving vehicle 31 are respectively 88° and 84°. In this embodiment, the image processor 103 calculates an average of the parking space angles I13 of the two entry corners 43, to define the parking space angle I13 of the entry line cluster. Therefore, referring to FIG. 19D, a parking space angle I13 of the parking space occupied by the surrounding vehicle 33 is defined as) 90.5° ((91° +90°/2), a parking space angle I13 of the parking space that the driving vehicle 31 is expected to park is defined as) 89° ((90° +88°/2), and a parking space angle I13 of the parking space on the right side of the driving vehicle 31 is defined as) 86° ((88° +84°/2).

In some other embodiments, the definition of the parking space angle I13 depends on the parking space type I23. In detail, the image processor 103 performs step S141 to define the parking space type I23 of the entry line cluster. When the parking space type I23 is determined as a parallel parking space par or the vertical parking space ver, the parking space angle I13 is 90 degrees, and the parking space angle I13 of the entry corner 43 may not be used as a reference. Therefore, in this embodiment, when the image processor 103 determines that the parking space type I23 belongs to the slant parking space slt, the average is calculated based on parking space angles I13 of two representative entry corners 43 of the entry line cluster, to define a representative parking space angle I13. However, when the image processor 103 determines that the parking space type I23 does not belong to the slant parking space slt (for example, the parallel parking space par or the vertical parking space ver), the representative parking space angle I13 is defined as 90 degrees. For example, referring to FIG. 19D, according to an algorithm of this embodiment, the parking space occupied by the surrounding vehicle 33 is the vertical parking space ver, and therefore the parking space angle I13 is directly defined as 90° (not shown in the figure). The parking space that the driving vehicle 31 is expected to park is the vertical parking space ver, and therefore the parking space angle I13 is directly defined as 90° (not shown in the figure). The parking space on the right side of the driving vehicle 31 is the slant parking space slt, and therefore the parking space angle I13 is defined as) 86° ((88° +84°/2).

Referring to FIG. 7 again, in step S15, the image processor 103 outputs parking space statistics information. In this embodiment, after collecting statistics on the coordinates I21 and the attributes of the plurality of entry lines 44 included in the entry line cluster to perform the information fusion, the image processor 103 outputs the representative coordinates I31, the representative parking space type I32, the representative parking space angle I33, and a representative occupancy state I34 of the entry line cluster. Referring to FIG. 6 again, in this embodiment, the image processor 103 outputs the representative coordinates I31 or the representative attribute to the controller 104. The controller 104 may control the vehicle to perform a parking action based on the representative coordinates I31 or the representative attribute of each parking space.

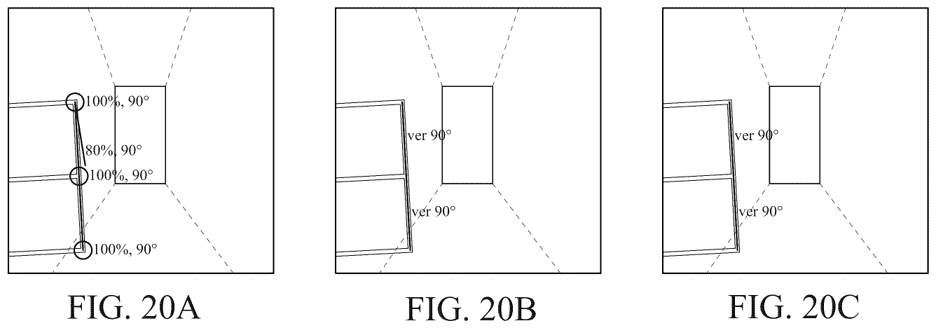

FIG. 20A is a schematic diagram of a panoramic image of parking space information according to some embodiments. FIG. 20B is a schematic diagram of a panoramic image of output information of an identification method according to some embodiments. FIG. 20C is a schematic diagram of a panoramic image of a verification result according to some embodiments. Refer to FIG. 20A to FIG. 20C in sequence. In this embodiment, an image identification model processes image information, and generates a plurality of entry corners 43 and a plurality of entry lines 44 of a parking space image. Information about the entry corners 43 and the entry lines 44 may correspond to one or more parking space images. A local parking space image is identified again through the image identification model, to confirm correspondences between each entry corner 43 and each entry line 44 and the parking space image, which may lead to a problem of repeated feature extraction.

In this embodiment, according to the identification method, through the processing of the entry corner 43 and the entry line 44 and information fusion, the plurality of entry corners 43 and the plurality of entry lines 44 in FIG. 20A are simplified into three entry corners 43 and two entry lines 44 in FIG. 20B, and clearly correspond to two parking space images. FIG. 20C shows a verification result obtained through identification of the local feature again based on the image identification model, which is consistent with a result obtained by processing through the identification method. In addition, through the identification method, operation processing time may be significantly reduced.

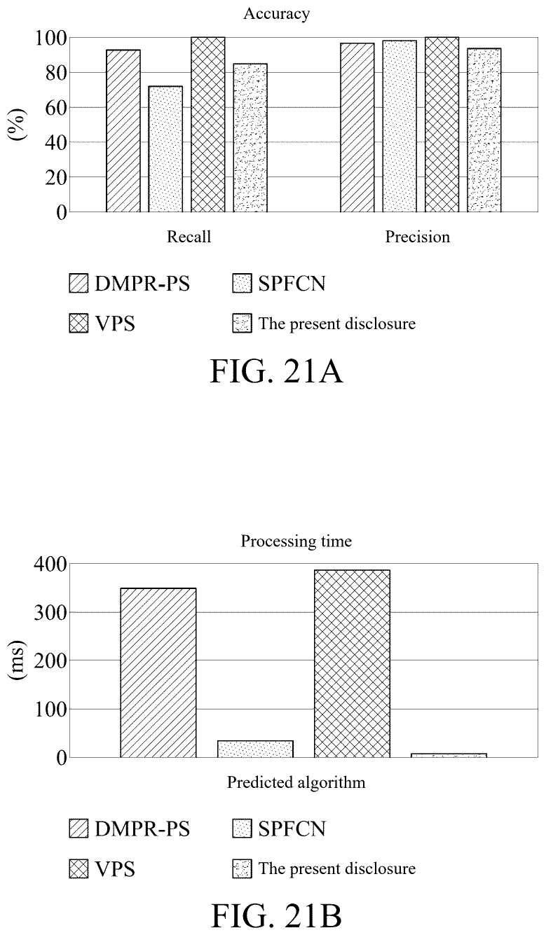

FIG. 21A to FIG. 21B are statistical comparison diagrams of an identification method according to some embodiments and an actual measurement result in the other algorithms. Algorithms compared in this embodiment include DMPR-PS (Huang, J., DMPR-PS: A novel approach for parking-slot detection using directional marking-point regression), SPFCN (Yu, Z., SPFCN: Select and prune the fully convolutional networks for real-time parking slot detection), VPS (Li, W., Vacant parking slot detection in the around view image based on deep learning), and the identification method in the present disclosure. A testing environment for each algorithm reaches a condition that a processor is fully loaded (400%).

Refer to FIG. 21A first. In FIG. 21A, a longitudinal axis represents a quantitative proportion, and a horizontal axis represents accuracy evaluation factors. The accuracy evaluation factors are divided into a recall and a precision. The recall represents a quantitative proportion of detected parking space images among all parking space images included in image information. The precision represents a quantitative proportion of actual parking spaces among all of the detected parking space images. In an actual test result of this embodiment, a recall of the identification method in the present disclosure is 85.09%, and the precision thereof is 94.38%. The recall is superior compared to the SPFCN, and the precision is slightly lower with no significant difference compared to existing algorithms. However, then refer to FIG. 21B. In FIG. 21B, a longitudinal axis represents processing time, and a horizontal axis represents algorithms. For a same image information set, a processing time of a processor applying the identification method in the present disclosure is 7.6 ms, a processing time of applying the DMPR-PS algorithm is 350 ms, a processing time of applying the SPFCN algorithm is 36 ms, and a processing time of applying the VPS algorithm is 389 ms. Accordingly, by using the identification method in the present disclosure, a more efficient processing speed than that of the other algorithms can be achieved, and a more reliable and sensitive vehicle control system can be provided, to improve overall traveling efficiency and safety.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. An identification method for parking space information fusion, applicable to a processor, wherein the identification method is configured for processing parking space information, the parking space information including a plurality of entry corners and one or more entry lines, and the identification method comprises:
processing and matching the plurality of entry corners and the one or more entry lines of the parking space information;
fusing information corresponding to the plurality of entry corners and the one or more entry lines, and parking space statistics information being generated; and
outputting the parking space statistics information.

2. The identification method of claim 1, wherein the step of processing and matching the plurality of entry corners and the one or more entry lines of the parking space information comprises:
grouping the plurality of entry corners into a plurality of entry corner clusters;
screening a representative entry corner included in each of the plurality of entry corner clusters; and
matching the one or more entry lines with the representative entry corner in each of the plurality of entry corner clusters, the one or more entry lines being grouped into one or more entry line clusters; and
the step of fusing the information corresponding to the plurality of entry corners and the one or more entry lines comprises:
collecting statistics on information about the one or more entry lines included in each of the one or more entry line clusters.

3. The identification method of claim 2, wherein each of the plurality of entry corners includes coordinates and an attribute, each of the one or more entry lines includes coordinates and an attribute, and the identification method further comprises:
grouping the plurality of entry corners into the plurality of entry corner clusters based on the coordinates of each of the plurality of entry corners;
screening the plurality of entry corners included in each of the plurality of entry corner clusters for the representative entry corner;
matching the one or more entry lines with the representative entry corner of the plurality of entry corner clusters based on the coordinates of each of the one or more entry lines, and the one or more entry lines into the one or more entry line clusters being grouped, wherein each of the one or more entry line clusters includes two representative entry corners of the plurality of entry corner clusters and one or more entry lines; and
collecting statistics based on the coordinates and the attribute of each of the one or more entry lines included in each of the one or more entry line clusters, to respectively define representative coordinates and a representative attribute for each of the one or more entry line clusters.

4. The identification method of claim 2, wherein in the step of grouping the plurality of entry corners into the plurality of entry corner clusters based on the coordinates of each of the plurality of entry corners, the identification method further comprises:
determining whether a distance between any two entry corners is less than a first distance threshold, in response to the distance between any two entry corners is less than a first distance threshold, grouping the any two of the plurality of entry corners into a same entry corner cluster.

5. The identification method of claim 2, wherein an attribute of each of the plurality of entry corners includes a probability value, and in the step of screening the plurality of entry corners included in each of the plurality of entry corner clusters for the representative entry corner, the identification method further comprises:
screening an entry corner of the plurality of entry corners with a maximum probability value as the representative entry corner based on a plurality of probability values of the plurality of entry corners included in each of the plurality of entry corner clusters.

6. The identification method of claim 5, wherein each of the one or more entry lines includes coordinates and an attribute, the coordinates of each of the one or more entry lines include two endpoints, and after the step of matching the one or more entry lines with the representative entry corner in each of the plurality of entry corner clusters based on the coordinates of each of the one or more entry lines, the one or more entry lines being grouped into the one or more entry line clusters, the identification method further comprises:
Retaining one of two of the one or more entry lines, when it is determined that any of the representative entry corner of the plurality of entry corner clusters is paired with one endpoint of each one of the two of the one or more entry lines, wherein a probability value of an another representative entry corner of the plurality of entry corner clusters paired with the other endpoint of the one of the two of the one or more entry lines entry line retained is greater than a probability value of an another representative entry corner paired with the other endpoint of the one of the two of the one or more entry lines entry line not retained.

7. The identification method of claim 6, wherein the coordinates of each of the one or more entry lines include a vector, and after the step of determining that any of the representative entry corner of the plurality of entry corner clusters is paired with the endpoint of each of the two entry lines, the identification method further comprises:
performing the step of retaining one of the two of the one or more entry lines when it is determined that the one endpoint of each one of the two of the one or more entry lines both correspond to an initial point or a terminal point of the vector.

8. The identification method of claim 6, wherein the coordinates of each of the one or more entry lines include a vector, and after the step of determining that any of the representative entry corner of the plurality of entry corner clusters is paired with one endpoint of each one of the two of the one or more entry lines, the identification method further comprises:
performing the step of retaining one of the two of the one or more entry lines when it is determined that the one endpoint of each one of the two of the one or more entry lines respectively correspond to an initial point and a terminal point of the vector and that an included angle between the two of the one or more entry lines is a numerical value outside a range of 90 degrees to 180 degrees.

9. The identification method of claim 2, wherein each of the one or more entry lines includes coordinates and an attribute, the coordinates of each of the one or more entry lines comprise two endpoints, and in the step of matching the one or more entry lines with the representative entry corner in each of the plurality of entry corner clusters based on the coordinates of each of the one or more entry lines, the one or more entry lines being grouped into the one or more entry line clusters, the identification method further comprises:
determining that a distance between one endpoint of any of the one or more entry lines and any of the representative entry corner of the plurality of entry corner clusters is less than a second distance threshold, and
matching the any of the one or more entry lines with the any of the representative entry corner of the plurality of entry corner clusters, and the any of the one or more entry lines being grouped into a same entry line cluster.

10. The identification method of claim 9, wherein in the step of matching the one or more entry lines with the representative entry corner in each of the plurality of entry corner clusters based on the coordinates of the one or more entry lines, the one or more entry lines being grouped into the one or more entry line clusters, the identification method further comprises:
determining whether the two endpoints of any of the one or more entry lines are not paired with the representative entry corner, in response to the two endpoints of any of the one or more entry lines are not paired with the representative entry corner, excluding the any entry line.

11. The identification method of claim 9, wherein in the step of matching the one or more entry lines with the representative entry corner in each of the plurality of entry corner clusters based on the coordinates of the one or more entry lines, the one or more entry lines being grouped into the one or more entry line clusters, the identification method further comprises determining whether the two endpoints of any of the one or more entry lines are both paired with a same representative entry corner, in response to the two endpoints of any of the one or more entry lines are both paired with the representative entry corner, excluding the any of the one or more entry lines.

12. The identification method of claim 2, wherein each of the one or more entry lines includes coordinates and an attribute, the attribute of each of the one or more entry lines comprises a parking space type, and the identification method further comprises:
finding a mode based on the parking space type of the one or more entry lines included in each of the one or more entry line clusters, and a representative parking space type of each of the one or more entry line clusters being defined.

13. The identification method of claim 12, wherein the attribute of the entry line includes an occupancy state, and the identification method further comprises:
finding a mode based on an occupancy state of the one or more entry lines included in each of the one or more entry line clusters, and a representative occupancy state of each of the one or more entry line clusters being defined.

14. The identification method of claim 2, wherein each of the one or more entry lines includes coordinates and an attribute, the coordinates of the entry line include two endpoints, an attribute of the entry corner includes a parking space angle, and the identification method further comprises:
calculating an average based on the parking space angles of two representative entry corners respectively paired with the two endpoints of each of the one or more entry lines, and a representative parking space angle of each of the one or more entry line clusters being defined.

15. The identification method of claim 14, wherein the attribute of the entry line includes a parking space type, and the identification method further comprises:
finding a mode based on a parking space type of the one or more entry lines included in each of the one or more entry line clusters, and a representative parking space type of each of the one or more entry line clusters being defined;
calculating an average based on the parking space angles of the two representative entry corners respectively paired with the two endpoints of each of the one or more entry lines when it is determined that the representative parking space type belongs to a slant parking space, and the representative parking space angle for each of the one or more entry line clusters being defined; and
defining the representative parking space angle of each of the one or more entry line clusters as 90 degrees when it is determined that the representative parking space type does not belong to the slant parking space.

16. The identification method of claim 2, wherein each of the one or more entry lines includes coordinates and an attribute, the coordinates of each of the one or more entry lines include two endpoints, and the identification method further comprises:
replacing the two endpoints based on coordinates of two representative entry corners respectively paired with the two endpoints of each of the one or more entry lines, representative coordinates for each of the one or more entry line clusters being defined.

17. An identification method for parking space information fusion, applicable to a processor, wherein the identification method is configured for processing image information, the image information includes a plurality of parking space images, and the identification method comprises:
executing an image identification model, and a plurality of entry corners and a plurality of entry lines of each of the plurality of parking space image being generated by the image identification model, and each of the plurality of entry corners comprises coordinates and an attribute, and each of the plurality of entry lines comprises coordinates and an attribute;
grouping the plurality of entry corners into a plurality of entry corner clusters based on the coordinates of each entry corner;
screening a plurality of entry corners included in each entry corner cluster for a representative entry corner;
matching the one or more entry lines with the representative entry corner in each of the plurality of entry corners based on the coordinates of the entry line, the one or more entry lines being grouped into one or more entry line clusters, wherein each of entry line cluster includes two representative entry corners and one or more entry lines; and
collecting statistics based on the coordinates and the attribute of the one or more entry lines included in each of the one or more entry line clusters, representative coordinates and a representative attribute being respectively defined for each of the entry line clusters.

18. An identification system for parking space information fusion, comprising:
a memory, configured to store parking space information, wherein the parking space information includes a plurality of entry corners and one or more entry lines; and
a processor, configured to:
read the parking space information from the memory;
process and match the plurality of entry corners and the one or more entry lines of the parking space information;
fuse information corresponding to the plurality of entry corners and the one or more entry lines, and parking space statistics information is generated; and
output the parking space statistics information.

19. The identification system of claim 18, wherein the processor is further configured to:
group the plurality of entry corners into a plurality of entry corner clusters;
screen a representative entry corner included in each of the plurality of entry corner clusters;
match the one or more entry lines with each representative entry corner, and the one or more entry lines are grouped into the one or more entry line clusters; and
collect statistics on information about the one or more entry lines included in each of the one or more entry line clusters.

20. The identification system of claim 19, wherein each of the plurality of entry corners comprises coordinates and an attribute, each of the one or more entry lines includes coordinates and an attribute, and the processor is further configured to:
group the plurality of entry corners into the plurality of entry corner clusters based on the coordinates of each of the plurality of entry corners;
screen the plurality of entry corners included in each of the plurality of entry corner clusters for the representative entry corner,
match the one or more entry lines with the representative entry corner in each of the plurality of entry corner clusters based on the coordinates of each of the one or more the entry lines, and the one or more entry lines into the one or more entry line clusters are grouped, wherein each of the one or more entry line clusters comprises two representative entry corners and the one or more entry lines; and
collect statistics based on the coordinates and the attribute of the one or more entry lines included in each of the plurality of entry line clusters, to respectively define representative coordinates and a representative attribute for each of the plurality of entry line clusters.
